(19) United States
(12) Patent Application Publication
(10) Pub. No.: US 2021/0354211 A1
(43) Pub. Date: Nov. 18, 2021

(54) FORWARD-REVERSE FEED HELICAL MILLING METHOD

(71) Applicant: DALIAN UNIVERSITY OF TECHNOLOGY, Dalian, Liaoning (CN)

(72) Inventors: Renke KANG, Dalian, Liaoning (CN); Zhigang DONG, Dalian, Liaoning (CN); Guolin YANG, Dalian, Liaoning (CN); Xianglong ZHU, Dalian, Liaoning (CN); Ping ZHOU, Dalian, Liaoning (CN); Shang GAO, Dalian, Liaoning (CN); Dongming GUO, Dalian, Liaoning (CN)

(21) Appl. No.: 17/051,626

(22) PCT Filed: May 4, 2018
(86) PCT No.: PCT/CN2018/085574

§ 371 Date: Jun. 28, 2021

(51) Int. Cl. B23C 3/02

(52) U.S. Cl. CPC B23C 3/02; B23C 2226/27; B23C 2220/52

(57) ABSTRACT

Disclosed is a method for helical milling with forward-backward feeding, including the following steps: determining the aperture D1 of a pre-processing hole; according to a final aperture D of a through-hole to-be-processed and the aperture D1 of the pre-processing hole, selecting a suitable tool; clamping the workpiece to-be-processed and the tool; the tool processes the pre-processing hole with forward feeding with aperture D1, D1<D, until the back-end cutting section of a cutting portion of the tool extends out of an outlet side; adjusting eccentricity of the tool one or more times, backward feeding from the outlet side, and using the back-end cutting section of the cutting portion of the tool to helical mill a through-hole with the aperture D. The present disclosure can avoid defects such as the delamination and tearing of a composite beyond processing requirements, improve the processing quality, save costs, simplify the processing process, increase the production efficiency of the tool and prolong the service life of the tool.

### TECHNICAL FIELD

The present disclosure relates to the technical filed of hole processing in the assembly of aerospace vehicle, in particular to a method for helical milling with forward-backward feeding.

### BACKGROUND ART

Composites are widely used in aerospace vehicle design, and hole processing problem of laminated structure of composite and metal is often encountered in the assembling process of aircraft. In the process of hole processing, there is usually no other support material on the back of the composite, in this case, delamination, tearing, burr and other processing defects often occur when the tool is cut from the back of the composite.

The common method of hole processing is drilling with drill bit, which will produce a larger axial cutting force. There is a new hole processing method to use a special end milling tool to conduct helical milling, whose axial cutting force is smaller than drilling, but still exists. Composite is usually composed of multi-layer fibers, the resin matrix material with weak strength is usually between different fiber layers, and the axial force in processing is the main cause of the machining damage of composites, when the tool is cut from one side of the composite, the fiber layer close to the outlet side deforms under the action of axial cutting force of the tool, and the resin matrix between different layers is pulled apart, forming delamination, tearing and other processing defects, which affect the hole quality. The processing defects formed at the outlet side of the drill hole are shown in FIG. 1, and the processing defects formed at the outlet side of the helical milling are shown in FIG. 2. If a backing plate is added to the back end of the composite, when the tool cutting close to the outlet side of the composite, the fibrous layer closed to the outlet side will be supported by the backing plate without large deformation, and the resin matrix between the fibrous layers will not be destroyed, avoiding the processing defects such as delamination and tearing. FIG. 3 shows the case of drill hole with backing plate, and FIG. 4 shows the case of helical milling with backing plate. However, in actual production, in some cases, the composite cannot be added with backing plate during hole processing; in other cases, although the backing plate can be added when hole processing, but the installation and removal of the backing plate will greatly increase production costs and reduce production efficiency.

Therefore, for the hole processing of composite without back support, it is an urgent technical problem to realize defect free and high quality hole processing without backing plate.

### SUMMARY OF THE INVENTION

According to the above technical problems, the present disclosure provided a method for helical milling with forward-backward feeding, so as to solve the problems such as easy lamination and tearing at the outlet of the composite and the disadvantage of time-consuming and laborious installation of backing plate. The present disclosure adopts the following technical solution:

A method for helical milling with forward-backward feeding, including the following steps:

S1. determining an aperture D1 of a pre-processing hole;

S2. selecting a suitable tool according to a final aperture D of a through-hole to-be-processed and the aperture D1 of the pre-processing hole;

S3. clamping a workpiece to-be-processed and the tool;

S4. feeding the tool forward to process the pre-processing hole with the aperture of D1, and D1<D, until a back-end cutting section of a cutting portion of the tool extending out of outlet side; and

S5. adjusting eccentricity of the tool one or more times, feeding backward from the outlet side, using the back-end cutting section of cutting portion of the tool to perform helical milling to obtain a through-hole with aperture D.

A determination method of the diameter D1 of the pre-processing hole in step S1 includes: according to the aperture D of the through-hole to-be-processed, a radial one-side maximum width K of a damage area required by processing, and a radial one-side maximum width K1 of a damage area produced by a pre-processing hole based on previous experiment data and production experience, D1 satisfies D1<D+2×K−2×K1, and the value of D1 is determined according to actual situation. The tool in step S2 includes a cutting portion, a neck portion and a handle portion; the cutting portion includes a front-end cutting section, a circumferential cutting section and a back-end cutting section; the front-end cutting section is a structure of drill bit or end mill; if the front-end cutting section is the drill bit structure, a diameter d of the cutting portion satisfies d=D1; if the front-end cutting section is the end mill structure, the diameter d of the cutting portion satisfies 0.5D<d<D1; a diameter d0 of the neck portion satisfies d0<d, a length h of the neck portion satisfies h>H, and His a hole depth of the through-hole to-be-processed.

Step S4 includes the following steps:

If the front-end cutting section of cutting portion of the tool is the drill bit structure, adjusting the tool coaxial with the through-hole to-be-processed, and feeding forward to process the pre-processing hole with the aperture D1 until the back-end cutting section of cutting portion of the tool extending out of the outlet side;

If the front-end cutting section of cutting portion of the selected tool is the mill end structure, adjusting the eccentricity e1 of the tool to e1=(D1−d)/2, driving the tool to helically mill with forward feeding to process the pre-processing hole with aperture D1 from the inlet side until the back-end cutting section of cutting portion of the tool extending out of the outlet side; wherein, d is a diameter of the cutting portion of the tool.

Step S5 includes the following steps:

S51. if D−Di<d−d0, adjusting the eccentricity e of the tool to e=(D−d)/2, helically milling with backward feeding from the outlet side to process a hole with aperture D and coaxial with the pre-processing hole, to obtain the through-hole to-be-processed; wherein, Di is an aperture at the outlet side after the previous helical milling (the drill hole is the helical milling of the tool with the eccentricity of 0), d is a diameter of cutting portion of the tool, d0 is a diameter of neck portion of the tool, and i=1, 2, 3, 4 . . . ;

if D−Di≥d−d0, adjusting the eccentricity e(i+1) of the tool to satisfy ei<e(i+1)<ei+(d−d0)/2, helically milling with backward feeding from the outlet side to process a through-hole coaxial with the pre-processing hole; and adjusting the eccentricity to e0<e(i+1) and feeding forward to make the back-end cutting section of cutting portion of the tool to extend out of the outlet side; wherein, Di is the aperture at the outlet side after the previous helical milling (the drill hole is the helical milling of the tool with the eccentricity of 0), d is the diameter of cutting portion of the tool, d0 is the diameter of neck portion of the tool, ei is an eccentricity of the tool when the aperture at the outlet is Di, and e(i+1) is an eccentricity of the tool in the present helical milling, i=1, 2, 3, 4 . . . ; and

S52. repeating step S51.

A driving device of the tool is a machining center, or special equipment for helical milling with eccentricity automatic adjustment function, or other processing equipment that can drive the tool to realize the motion required by the present disclosure.

A method for helical milling with backward feeding from the outlet side includes: the tool feeds to the outlet side along a helical path while it rotates at a high speed, and perform helical milling on the outlet side by the back-end cutting section of cutting portion of the tool.

If the workpiece only contains a monolayer composite, in order to avoid new machining damage on the inlet side when helical mill with backward feeding from the outlet side, before step S5, the tool helically mills with forward feeding from the inlet side to obtain a hole with an aperture D, a hole depth H1 and coaxial with the pre-processing hole, and the tool feeds forward after the eccentricity is reduced until the back-end cutting section of cutting portion of the tool extends out of the outlet side; wherein, H1<H, and H is the hole depth of the through hole.

The special steps of step S5 includes: Adjusting the eccentricity of the tool one or more times, helically milling with backward feeding from the outlet side, processing a hole with an aperture D, a hole depth H−H1 and coaxial with the pre-processing hole, to obtain the through-hole to-be-processed; the front-end cutting section of cutting portion of the tool is the end milling structure.

Compared with the prior art, the present disclosure has the following beneficial effects:

1. The present disclosure can avoid delamination, tearing and other defects of the composite beyond the processing requirements, and improve the processing quality. When the workpiece to-be-processed is a laminated structure including at least one layer of composite and at least one layer of metal material, in the process of machining pre-processing hole, there is no backing plate on the back of the composite, which may produce larger processing defects, but the defective material can be cut off in the process of subsequent helical milling with backward feeding, and no new processing defects will be produced in the process of helical milling with backward feeding. This is due to the change of the direction of axial force on the composite during the process of helical milling with backward feeding, the fibrous layer on the outlet side will not produce deformation that may lead to delamination and tearing. When the tool nears to the interface between the composite layer and the metal layer in backward feeding of helical milling, the mental layer can act as a backing plate, so that the fibrous layer of the composite here does not appear delamination, tearing and other defects;

If the workpiece only contains composite, in the process of machining pre-processing hole with helical milling, there is no backing plate on the back of the composite, which may produce larger processing defects, but the defective material can be cut off in the process of subsequent helical milling with backward feeding, and no new processing defects will be produced in the process of helical milling with backward feeding. When the tool helically mills with forward feeding to process the first half section (H1) of the processing-hole, the second half of the material can be used as the backing plate for the first half processing, so that the fiber layer of the composite here will not appear delamination, tearing and other defects; when helically mill the second half of the material with backward feeding, the direction of axial force on the composite is changed, and the first half of the material can be used as the backing plate for the second half processing, so that the fibrous layer of the composite here does not appear delamination, tearing and other defects.

2. The outlet side of the composite does not need extra backing plates, which saves on costs, simplifies the machining process and improves production efficiency.

3. The present disclosure reduced the difficulty of the tool design. When the front-end cutting section of the tool performs forward feeding processing, processing defects within a certain scale are allowed, which is equivalent to reducing the design requirements of the edge shape of the front-end cutting section of the tool and makes it easier to obtain usable tools.

4. The present disclosure can improve the life of the tool. When the front-end cutting section of the tool performs forward feeding processing, processing defects within a certain scale are allowed. Therefore, when the front-end cutting edge of the tool's front-end cutting section has a certain wear, the tool can continue to be used even if the processing quality decreases, until the resulting processing defects exceed the allowable value. When the back-end cutting section is used for helical milling in backward feeding, the metal layer or composite can act as the backing plate, therefore, even if some wear is produced, there will be no processing defects near the metal side of the composite.

Based on the above effects, the present disclosure can be widely used in the field of hole processing.

### BRIEF DESCRIPTION OF THE DRAWINGS

In order to more clearly illustrate the embodiments of the present disclosure or the technical solutions in the prior art, the drawings required in the description of the embodiments or the prior art will be briefly introduced below. Obviously, the drawings in the following descriptions are some embodiments of the present disclosure. For those of ordinary skilled in the art, other drawings can be obtained based on these drawings without inventive effort.

FIG. 1 is a schematic diagram of the formation of machining damage at the outlet side of composite under the existing drilling processing method in the background art of the present disclosure.

FIG. 2 is a schematic diagram of the formation of machining damage at the outlet side of composite under the existing helical milling processing method in the background art of the present disclosure.

FIG. 3 is a schematic diagram of the inhibition of machining damage when there is a backing plate on the outlet side of composite under the existing drilling processing method in the background art of the present disclosure.

FIG. 4 is a schematic diagram of the inhibition of machining damage when there is a backing plate on the outlet side of composite under the existing helical milling processing method in the background art of the present disclosure.

FIG. 5 is a flow diagram of a method for helical milling with forward-backward feeding in the embodiments.

FIG. 6 is a structure diagram of the tool in embodiment 1 and embodiment 3 of the present disclosure.

FIG. 7 is a processing diagram in embodiment 1 of the present disclosure.

FIG. 8 is a comparison diagram of the processing effects between the final hole and the pre-processing hole by using the method disclosed in embodiment 1, the final hole was obtained by processing a laminated structure of composite and metal, and the pre-processing hole was obtained by helical milling the laminated structure with forward feeding from the inlet side at the first time.

FIG. 9 is a structure diagram of the tool in embodiment 2 of the present disclosure.

FIG. 10 is a processing diagram in embodiment 2 of the present disclosure.

FIG. 11 is a comparison diagram of the processing effects between the final hole and the pre-processing hole by using the method disclosed in embodiment 2, the final hole was obtained by processing a laminated structure of composite and metal, and the pre-processing hole was obtained by drilling the laminated structure with forward feeding from the inlet side for the first time.

FIG. 12 is a processing diagram in embodiment 3 of the present disclosure.

FIG. 13 is a comparison diagram of the processing effects between the final hole and the pre-processing hole by using the method disclosed in embodiment 3, the final hole was obtained by processing the composite, and the pre-processing hole was obtained by helical milling the composite with forward feeding from the inlet side at the first time.

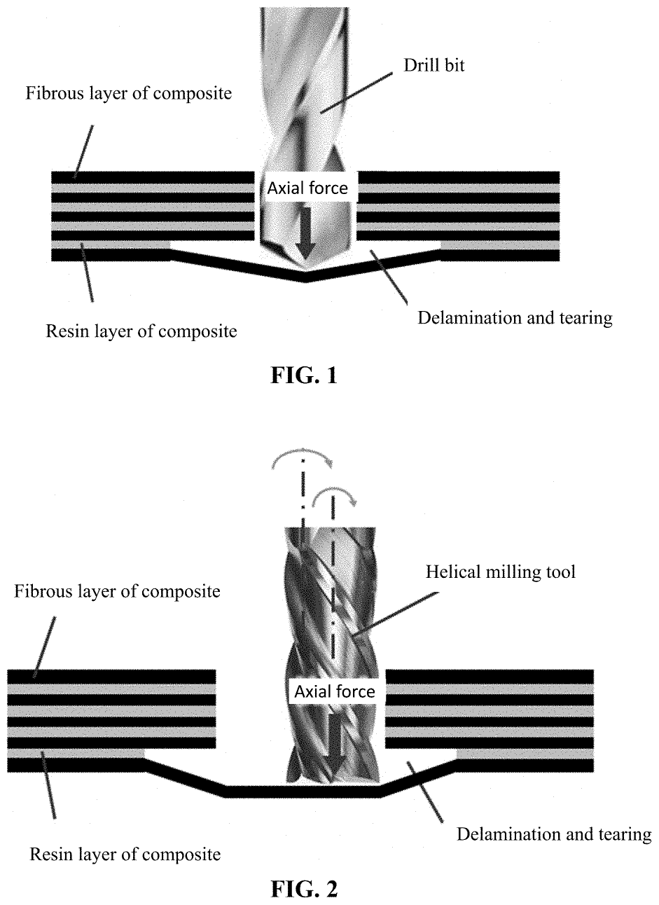

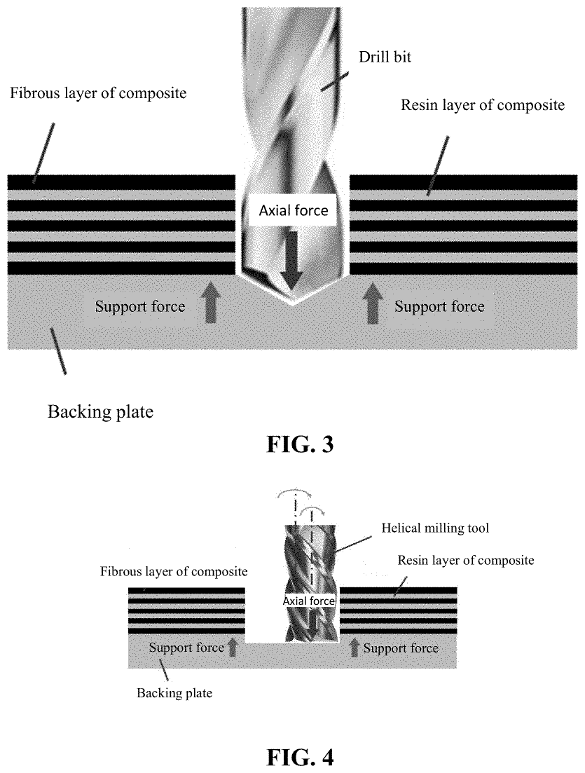

### DETAILED DESCRIPTION OF THE PREFERRED EMBODIMENTS

To make the objectives, technical solutions and advantages of the present disclosure clearer, a clear and complete description in the embodiments of the present disclosure may be given herein after in combination with the accompany drawings in the embodiment of the present disclosure. Obviously, the described embodiments are parts of the embodiments of the present disclosure, but not all of them. Based on the embodiments in the present disclosure, all other embodiments obtained by those of ordinary skilled in the art without inventive effort are within the scope of the present disclosure.

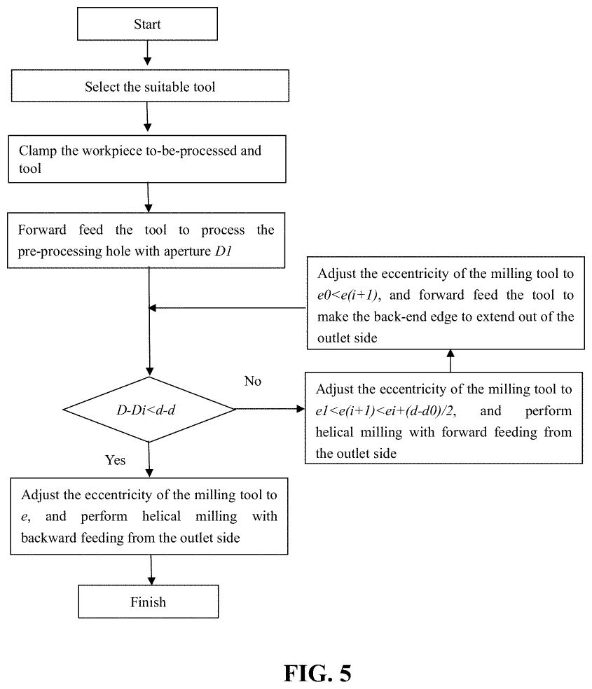

FIG. 5 is a schematic diagram of method for helical milling with forward-backward feeding, which is suitable for the processing of composite, metal and laminated material. The directional terms mentioned in the present disclosure, such as up, down, left, right, etc., only refer to the directions of the attached drawings. Therefore, the directional terms are used to illustrate rather than limit the present disclosure.

The present disclosure is applicable to the hole processing of laminated structure of composite and metal, and is also applicable to that of monolayer composite, composite lamination, monolayer metal, and metal lamination material, to avoid the machining defects such as burr and flash on the outlet side.

The composites mentioned in the present disclosure mainly refer to carbon fiber reinforced resin matrix composite, but also include other composites with different fibers and matrix materials. The metal material mainly includes but not limited to titanium alloy, aluminum alloy, high-strength steel and other metal materials.

The processing defects mentioned in the present disclosure include but not limited to delamination and tearing. The present disclosure is also applicable to other defects caused by the absence of backing plate at the outlet side, or other processing defects with the same characteristics as delamination and tearing but with different names.

If there are holes, such as pre-drilling holes, small holes, guide holes, blind holes, inclined holes, and poor holes, whose diameter is smaller than the through-hole to-be-processed on the workpiece, the hole processing can still be performed according to the method of the present disclosure without considering those holes.

If a small through-hole that has already existed on the workpiece allows the cutting portion of the tool to extend out, and the length of the neck portion of the tool is longer than the hole depth of the through-hole to-be-processed, the present disclosure can also be used to conduct backward reaming.

A method for helical milling with forward-backward feeding, including the following steps:

S1. determining an aperture D1 of a pre-processing hole;

S2. selecting a suitable tool according to a final aperture D of a through-hole to-be-processed and the aperture D1 of the pre-processing hole;

S3. clamping a workpiece to-be-processed and the tool;

S4. feeding the tool forward to process the pre-processing hole with aperture D1, and D1<D, until a back-end cutting section of cutting portion of the tool extending out of outlet side; and

S5. adjusting eccentricity of the tool one or more times, feeding backward from the outlet side, using the back-end cutting section of cutting portion of the tool to perform helical milling to obtain a through-hole with aperture D.

A determination method of the aperture D1 of the pre-processing hole in step S1 includes: according to the aperture D of the through-hole to-be-processed, a radial one-side maximum width K of a damage area required by processing, and a radial one-side maximum width K1 of a damage area produced by a pre-processing hole based on previous experiment data and production experience, and D1 satisfies: D1<D+2×K−2×K1, and the value of D1 is determined according to actual situation.

The tool in step S2 includes a cutting portion, a neck portion and a handle portion; the cutting portion includes a front-end cutting section, a circumferential cutting section and a back-end cutting section; the front-end cutting section is a structure of drill bit or end mill; if the front-end cutting section is the drill bit structure, a diameter d of the cutting portion satisfies d=D1; if the front-end cutting section is the end mill structure, the diameter d of the cutting portion satisfies 0.5D<d<D1, a diameter d0 of the neck portion satisfies d0<d, a length h of the neck portion satisfies h>H, and His a hole depth of the through-hole to-be-processed.

Step S4 includes the following steps:

If the front-end cutting section of the cutting portion of the selected tool is the drill bit structure, adjusting the tool coaxial with the through-hole to-be-processed, and feeding forward to process the pre-processing hole with aperture D1 until the back-end cutting section of the cutting portion of the tool extending out of the outlet side.

If the front-end cutting section of the cutting portion of the selected tool is the mill end structure, adjusting the eccentricity e1 of the tool to e1=(D1−d)/2, driving the tool to helically mill with forward feeding to process the pre-processing hole with aperture D1 from the inlet side until the back-end cutting section of the cutting portion of the tool extending out of the outlet side; wherein, d is a diameter of the cutting portion of the tool.

Step S5 has the following steps:

S51. if D−Di<d−d0, adjusting the eccentricity e of the tool to e=(D−d)/2, helically milling with backward feeding from the outlet side to process a hole with aperture D and coaxial with the pre-processing hole, to obtain the through-hole to-be-processed; wherein, Di is an aperture at the outlet side after the previous helical milling, d is the diameter of the cutting portion of the tool, d0 is a diameter of the neck portion of the tool, and i=1, 2, 3, 4 . . . ;

If D−Di≥d−d0, adjusting the eccentricity e(i+1) of the tool to satisfy ei<e(i+1)<ei+(d−d0)/2, helically milling with backward feeding from the outlet side to process a hole coaxial with the pre-processing hole; and adjusting the eccentricity to e0<e(i+1) and feeding forward to make the back-end cutting section of the cutting portion of the tool to extend out of the outlet side; wherein, Di is the aperture at the outlet side after the previous helical milling, d is the diameter of the cutting portion of the tool, d0 is the diameter of the neck portion of the tool, ei is an eccentricity of the tool when the aperture at the outlet is Di, e(i+1) is an eccentricity of the tool in the present helical milling, and i=1, 2, 3, 4 . . . ;

Step S52. repeating step S51.

A driving device of the tool is a machining center, or special equipment for helical milling with eccentricity automatic adjustment function, or other processing equipment that can drive the tool to realize the motion required by the present disclosure.

A method for helical milling with backward feeding from the outlet side includes: the tool feeds to the outlet side along a helical path while it rotates at a high speed, and perform helical milling of the outlet side by the back-end cutting section of the cutting portion of the tool.

If the workpiece only contains a monolayer composite, in order to avoid new machining damage on the inlet side when helical mill with backward feeding from the outlet side, before step S5, the tool helically mills with forward feeding from the inlet side to obtain a hole with an aperture D, a hole depth H1 and coaxial with the pre-processing hole, and the tool feeds forward after the eccentricity is reduced until the back-end cutting section of the cutting portion of the tool extends out of the outlet side; wherein, H1<H, and H is the hole depth of the through hole.

The detailed steps of step S5 include:

Adjusting the eccentricity of the tool one or more times, helically milling with backward feeding from the outlet side, processing a hole with aperture D, a hole depth H−H1 and coaxial with the pre-processing hole, to obtain the through hole to-be-processed. The front-end cutting section of the cutting portion of the tool is an end milling structure.

### Embodiment 1

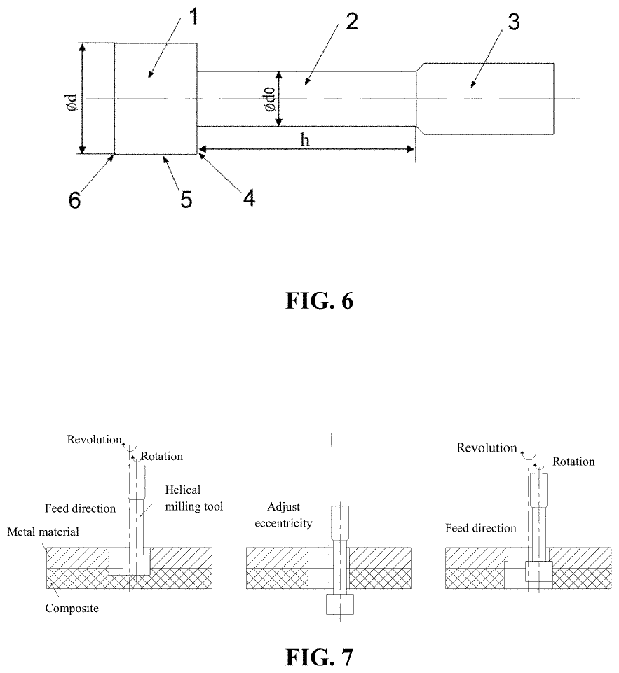

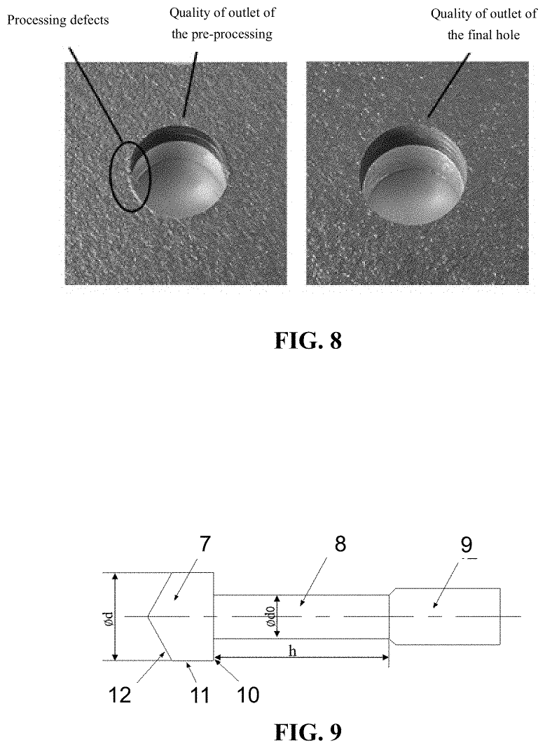

FIG. 6 and FIG. 7 are respectively the tool structure diagram and processing diagram of method for helical milling with forward-backward feeding. FIG. 8 is a comparison diagram of the processing effects between the final hole and the pre-processing hole by using the method disclosed in the embodiment, the final hole was obtained by processing a laminated structure of composite and metal, and the pre-processing hole was obtained by helical milling the laminated structure with forward feeding from the inlet side at the first time. The workpiece to-be-processed is a laminated structure of composite and metal, the aperture D of the through-hole to-be-processed is 14 mm, the hole depth H of the through-hole to-be-processed is 20 mm, the radical one-side maximum width K of the damage area required by processing is 0; and the method includes the following steps:

S1. An aperture D1 of a pre-processing hole is determined:

according to the aperture D (14 mm) of the through-hole to-be-processed, the radical one-side maximum width K (0) of the damage area required by processing, and the radical one-side maximum width K1 (0.5 mm) of the damage area produced by helical milling the pre-processing hole based on the previous experiment data and production experience, D1 satisfies D1<D+2×K−2×K1; according to actual situation, D1 is determined to be 12 mm; S2. A suitable tool is selected according to a final aperture D of the through-hole to-be processed and the aperture D1 of the pre-processing hole;

the tool includes a cutting portion 1, a neck portion 2 and a handle portion 3; the cutting portion includes a front-end cutting section 6, a circumferential cutting section 5 and a back-end cutting section 4; the front-end cutting section 6 is the end mill structure, the diameter d of the cutting portion 1 satisfies 0.5D<d<D1, the diameter d0 of the neck portion 2 satisfies d0<d, the length h of the neck portion satisfies h>H; when feed the tool forward until the back-end cutting section 4 of the cutting portion 1 of the tool extends out of the outlet side, the handle portion 3 does not enter the hole; the selected tool is d=8 mm, d0=7 mm, and h=30 mm;

S3. The workpiece to-be-processed and the tool are clamped:

the workpiece to-be-processed is a laminated structure, including a layer of composite and a layer of metal material; the tool is clamped on a device which can rotate and can revolve with a certain eccentricity, so that the axis of the tool is parallel to that of the through-hole to-be-processed;

S4. The tool is fed forward to process the pre-processing hole with aperture D1 (D1<D), until the back-end cutting section 4 of the cutting portion 1 of the tool extends out of the outlet side;

the front-end cutting section 6 of the cutting portion 1 of the selected tool is the end mill structure, the eccentricity e1 of the tool is adjusted to e1=(D1−d)/2=2 mm, a driving device drives the tool to helically mill with forward feeding from the inlet side to process the pre-processing hole with aperture D1, until the back-end cutting section 4 of the cutting portion 1 of the tool extends out of the outlet side; the driving device is a machining center, or a special equipment for helical milling with eccentricity automatic adjustment function, or other machining equipment which can drive the tool to realize the motion required in this embodiment.

S5. The eccentricity of the tool is adjusted one or more times, the tool is fed backward from the outlet side, and the through-hole with aperture D is helically milled by the back-end cutting section 4 of the cutting portion 1 of the tool; the specific steps are as followed:

S51. When D−D1=2 mm, d−d0=1 mm, then D−D1≥d−d0, the eccentricity of the tool is adjusted to e(1+1)=2.4 mm, satisfying e1<e(1+1)<e1+(d−d0)/2, the tool helically mills with backward feeding from the outlet side, a through-hole coaxial with the pre-processing hole is processed; the tool is fed to the outlet side along a helical path while it rotates at a high speed, and the helical milling is performed at the outlet side by using the back-end cutting section 4 of the cutting portion 1 of the tool. The eccentricity of the tool is adjusted to e0=2.3 mm<e(1+1), the tool is fed forward to make the end cutting section 4 of the cutting portion 1 of the tool extends out of the outlet side;

S52. When D−D2=1.2 mm, d−d0=1 mm, then D−D2>d−d0, the eccentricity of the tool is adjusted to e(2+1)=2.7 mm, satisfying e2<e(2+1)<e2+(d−d0)/2, the tool helically mills with backward feeding from the outlet side, a through-hole coaxial with the pre-processing hole is processed; the tool is fed to the outlet side along a helical path while it rotates at a high speed, and the helical milling is performed at the outlet side by using the back-end cutting section 4 of the cutting portion 1 of the tool, the eccentricity of the tool is adjusted to e0=2.3 mm<e(2+1), the tool is fed forward to make the end cutting section 4 of the cutting portion 1 of the tool extends out of the outlet side; and D2 is the aperture of the outlet side obtained in step S51;

S53. When D−D3=0.6 mm, d−d0=1 mm, then D−D3<d−d0, the eccentricity of the tool is adjusted to e=(D−d)/2=3 mm, the tool helically mills with backward feeding from the outlet side, a hole with aperture D and coaxial with the pre-processing hole is processed, i.e. the through-hole to-be processed; D3 is the aperture of the outlet side obtained in step S52.

### Embodiment 2

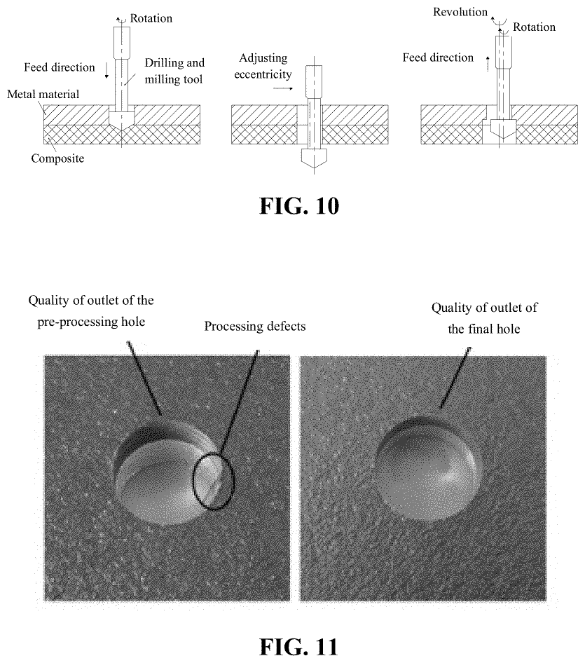

FIG. 9 and FIG. 10 are respectively the tool structure diagram and processing diagram of method for helical milling with forward-backward feeding. FIG. 11 is a comparison diagram of the processing effects between the final hole and the pre-processing hole by using the method disclosed in the embodiment, the final hole was obtained by processing composite and metal laminated structure, and the pre-processing hole was obtained by helical milling the laminated structure with forward feeding from the inlet side at the first time. The workpiece to-be-processed is a laminated structure of composite and metal, the aperture D of the through-hole to-be-processed is 14 mm; the depth H of the through-hole to-be-processed is 20 mm, the radical one-side maximum width K of radical side of the damage area required by processing is 0; and the method includes the following steps:

S1. An aperture D1 of a pre-processing hole is determined:

according to the aperture D (=14 mm) of the through-hole to-be-processed, the radical one-side maximum width K (=0) of the damage area required by processing, and the radical one-side maximum width K1 (=ham) of the damage area produced by drilling a pre-processing hole based on the previous experiment data and production experience, D1 satisfies D1<D+2×K−2×K1; according to actual situation, D1 is determined to be 10 mm;

S2. A suitable tool is selected according to a final aperture D of the through-hole to-be processed and the aperture D1 of the pre-processing hole;

the tool includes a cutting portion 7, a neck portion 8 and a handle portion 9; the cutting portion includes a front-end cutting section 12, a circumferential cutting section 11 and a back-end cutting section 10; the front-end cutting section 12 is the drill bit structure, the diameter d of the cutting portion 7 satisfies d=D1, the diameter d0 of the neck portion 8 satisfies d0<d, and the length h of the neck portion 8 satisfies h>H; when feed the tool forward until the back-end cutting section 10 of the cutting portion 7 of the tool extends out to the outlet side, the handle portion 9 does not enter the hole; the selected tool is d=10 mm, d0=8 mm, and h=30 mm;

S3. The workpiece to-be-processed and the tool are clamped:

the workpiece to-be-processed is a laminated structure, including a layer of composite and a layer of metal material; the tool is clamped on a device which can rotate and can revolve with a certain eccentricity, so that the axis of the tool is parallel to that of the through-hole to-be-processed;

S4. The tool is fed forward to process the pre-processing hole with aperture D1 (D1<D), until the back-end cutting section 10 of the cutting portion 7 of the tool extends out of the outlet side;

the front-end cutting section 12 of the cutting portion 7 of the selected tool is the drill bit structure, the eccentricity e1 of the tool is adjusted to e1=0, a driving device drives the tool to drill with forward feeding from the inlet side to process the pre-processing hole with aperture D1, until the back-end cutting section 10 of the cutting portion 7 of the tool extends out of the outlet side; the driving device is a machining center, or a special equipment for helical milling with eccentricity automatic adjustment function, or other machining equipment which can drive the tool to realize the motion required in this embodiment.

S5. The eccentricity of the tool is adjusted one or more times, the tool is fed backward from the outlet side, and the through-hole with aperture D is helically milled by the back-end cutting section 10 of the cutting portion 7 of the tool; the specific steps are as followed:

S51. When D−D1=4 mm, d−d0=2 mm, then D−D1≥d−d0, the eccentricity of the tool is adjusted to e(1+1)=0.8 mm, satisfying e1<e(1+1)<e1+(d−d0)/2, the tool helically mills with backward feeding from the outlet side, a through-hole coaxial with the pre-processing hole is processed; the tool is fed to the outlet side along a helical path while it rotates at a high speed, and the helical milling is performed at the outlet side by using the back-end cutting section 10 of the cutting portion 7 of the tool. The eccentricity of the tool is adjusted to e0=0.7 mm<e(1+1), the tool is fed forward to make the end cutting section 10 of the cutting portion 7 of the tool extends out of the outlet side;

S52. when D−D2=2.4 mm, d−d0=2 mm, then D−D2≥d−d0, the eccentricity of the tool is adjusted to e(2+1)=1.6 mm, satisfying e2<e(2+1)<e2+(d−d0)/2, the tool helically mills with backward feeding from the outlet side, a through-hole coaxial with the pre-processing hole is processed; the tool is fed to the outlet side along a helical path while it rotates at a high speed, and the helical milling is performed at the outlet side by using the back-end cutting section 10 of the cutting portion 7 of the tool, the eccentricity of the tool is adjusted to e0=1.4 m<e(2+1), the tool is fed forward to make the end cutting section 10 of the cutting portion 7 of the tool extends of the outlet side; and D2 is the aperture of the outlet side obtained in step S51;

S53. When D−D2=0.8 mm, d−d0=2 mm, then D−D3<d−d0, the eccentricity of the tool is adjusted to e=(D−d)/2=2 mm, the tool helically mills with backward feeding from the outlet side, a hole with aperture D and coaxial with the pre-processing hole is processed, i.e. the through-hole to-be processed; D3 is the aperture of the outlet side obtained in step S52.

### Embodiment 3

The workpiece to-be-processed contains only a monolayer composite, in order to avoid the new machining damage generated on the inlet side when helical mill with backward feeding from the outlet side, the embodiment is that the tool first helically mills a first half section of the processing-hole with forward feeding, then helically mills the second half section of the processing-hole with backward feeding. When backward feeding, the first half of the composite can be used as a backing plate, so that the fiber layer of the composite here does not appear defects such as delamination or tearing. Any hole processing consistent with the action principle of the method in this embodiment shall be within the protection scope of the present disclosure.

In this embodiment, a very small machining allowance can be maintained in the process of helically milling the first half section of the processing-hole with forward feeding and helically milling the second half section of the processing-hole with backward feeding, and then all of them are processed to the final aperture in one time by using helical milling, which can avoid producing the tool marks.

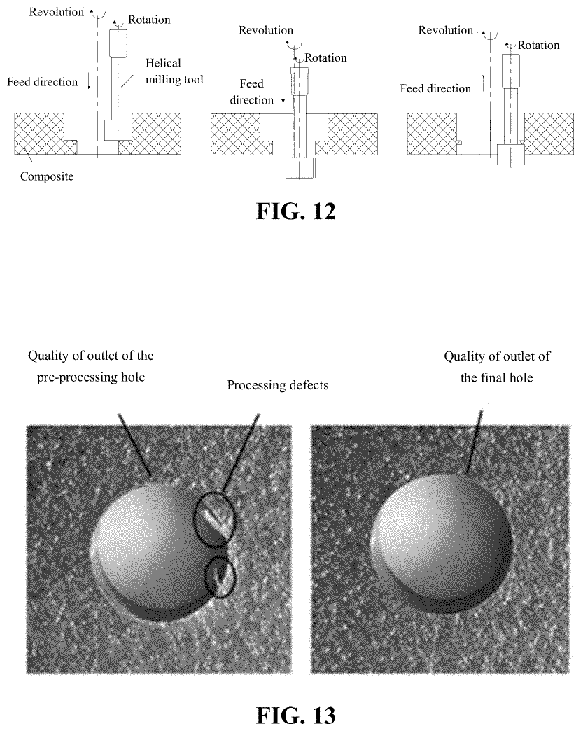

FIG. 6 and FIG. 12 are respectively the tool structure diagram and a processing diagram of method for helical milling with forward-backward feeding. FIG. 13 is a comparison diagram of the processing effects between the final hole and the pre-processing hole by using the method disclosed in the embodiment, the final hole was obtained by processing composite, and the pre-processing hole was obtained by helical milling with forward feeding from the inlet side at the first time. The workpiece to-be-processed is a monolayer composite, the aperture D of the through-hole to-be-processed is 16 mm, the depth H of the through-hole to-be-processed is 20 mm, the radical one-side maximum width K of the damage area required by processing is 0.5 mm; and the method includes the following steps:

S1. An aperture D1 of a pre-processing hole is determined:

the calculation method of D1 is: according to the aperture D (=16 mm) of the through-hole to-be-processed, the radical one-side maximum width K (=0.5 mm) of the damage area required by processing and the radical one-side maximum width K1 (=0.8 mm) of the damage area produced by helical milling the pre-processing hole based on the previous experiment data and production experience, D1 satisfies D1<D+2×K−2×K1; according to actual situation, D1 is determined to be 14 mm;

S2. A suitable tool is selected according to a final aperture D of the through-hole to-be processed and the aperture D1 of the pre-processing hole;

the tool is selected as: the tool includes a cutting portion 1, a neck portion 2 and a handle portion 3; the cutting portion 1 includes a front-end cutting section 6, a circumferential cutting section 5 and a back-end cutting section 4; the front-end cutting section 6 is the end mill structure, the diameter d of the cutting portion 1 is 8 mm satisfying 0.5D<d<D1, the diameter d0 of the neck portion 2 is 6 mm satisfying d0<d, the length h of the neck portion 2 is 30 mm; when feed the tool forward until the back-end cutting section 4 of the cutting portion 1 of the tool extends out of the outlet side, the handle portion 3 does not enter the hole;

S3. The workpiece to-be-processed and the tool are clamped:

The workpiece to-be-processed is a monolayer composite structure; the tool is clamped on a device which can rotate and can revolve with a certain eccentricity, so that the axis of the tool is parallel to that of the through-hole to-be-processed;

S4. The tool is fed forward to process the pre-processing hole with aperture D1 (D1<D), until the back-end cutting section 4 of the cutting portion 1 of the tool extends out of the outlet side;

The eccentricity e1 of the tool is adjusted to e1=(D1−d)/2=3 mm (d is the diameter of the cutting portion 1 of the tool), a driving device drives the tool to drill with forward feeding from the inlet side to process the pre-processing hole with the aperture of D1; the driving device can be a machining center, or a special equipment for helical milling with an eccentricity automatic adjustment function, or other machining equipment which can drive the tool to realize the motion required in this embodiment; when helical milling, the tool rotates at a high speed and forward feeds until the back-end cutting section 4 is detached from the workpiece to-be-processed, meanwhile, ensure that the handle portion 3 does not enter the hole;

S5. The tool is fed backward until the front-end cutting section 6 of the cutting portion 1 of the tool quits the inlet side;

S6. When d=8 mm, (D−D1)/2=1 mm, then d>(D−D1)/2, the eccentricity of the tool is adjusted to e=(D−d)/2=4 mm, a hole with aperture D=16 mm, hole depth H1=14 mm, and coaxial with the pre-processing hole is processed with forward feeding from the inlet side;

S7. the eccentricity of the tool is adjusted to e0=2.8 mm<e1, the tool is fed forward until the end-end cutting section 4 of the cutting portion 1 of the tool extends out of the outlet side;

S8. the eccentricity of the tool is adjusted one or more times, the tool is fed forward from the outlet side, and the through-hole with aperture D is helical milled by the back-end cutting section 4 of the cutting portion 1 of the tool; and the specific steps are as followed:

S81. when D−D1=2 mm, d−d0=2 mm, then D−D1=d−d0, the eccentricity of the tool is adjusted to e(1+1)=3.5 mm satisfying e1<e(1+1)<e1+(d−d0)/2, the tool helically mills with backward feeding from the outlet side, a through-hole with hole depth H−H1=6 mm and coaxial with the pre-processing hole is processed; the tool is fed to the outlet side along a helical path while it rotates at a high speed, and the helical milling is carried out on the outlet side by using the back-end cutting section 4 of the cutting portion 1 of the tool. The eccentricity of the tool is adjusted to e0<e(1+1), the tool is fed forward to make the end cutting section 4 of the cutting portion 1 of the tool extends out of the outlet side;

S82. When D−D2=1 mm, d−d0=2 mm, then D−D2<d-d0, the eccentricity of the tool is adjusted to e=(D−d)/2=4 mm, the tool helically mills with backward feeding from the outlet side, a hole with aperture D and coaxial with the pre-processing hole is processed, i.e. the through-hole to-be processed; D2 is the aperture of the outlet side obtained in step S81.

Finally, it should be stated that the above embodiments are only used to illustrate the technical solutions of the present disclosure without limitation; and despite reference to the aforementioned embodiments to make a detailed description of the present disclosure, those of ordinary skilled in the art should understand: the described technical solutions in above various embodiments may be modified or the part of or all technical features may be equivalently substituted; while these modifications or substitutions do not make the essence of their corresponding technical solutions deviate from the scope of the technical solutions of the embodiments of the present disclosure.

1. A method for helical milling with forward-backward feeding, comprising the following steps:
S1. determining an aperture D1 of a pre-processing hole;
S2. selecting a suitable tool according to a final aperture D of a through-hole to-be-processed and the aperture D1 of the pre-processing hole;
S3. clamping a workpiece to-be-processed and the tool;
S4. feeding the tool forward to process the pre-processing hole with the aperture D1, and D₁<D, until a back-end cutting section of cutting portion of the tool extending out of outlet side; and
S5. adjusting eccentricity of the tool one or more times, feeding backward from the outlet side, using the back-end cutting section of cutting portion of the tool to perform helical milling, obtaining a through-hole with aperture D.

2. The method according to claim 1, wherein a determination method of the aperture D1 of the pre-processing hole in step S1 comprises: according to the aperture D of the through-hole to-be-processed, a radial one-side maximum width K of a damage area required by processing, and a radial one-side maximum width K1 of a damage area produced by a pre-processing hole based on previous experiment data and production experience, D1 satisfies:
D1<D+2×K−2×K1, and the value of D1 is determined according to actual situation.

3. The method according to claim 1, wherein the tool in step S2 comprises a cutting portion, a neck portion and a handle portion; the cutting portion comprises a front-end cutting section, a circumferential cutting section and a back-end cutting section; the front-end cutting section is a structure of drill bit or end mill; if the front-end cutting section is the drill bit structure, a diameter d of the cutting portion satisfies d=D1; if the front-end cutting section is the end mill structure, the diameter d of the cutting portion satisfies 0.5D<d<D1; a diameter d0 of the neck portion satisfies d0<d; a length h of the neck portion satisfies h>H, and H is a hole depth of the through-hole to-be-processed.

4. The method according to claim 3, wherein step S4 comprises the following steps:
if the front-end cutting section of cutting portion of the tool is drill bit structure, adjusting the tool coaxial with the through-hole to-be-processed, and feeding forward to process the pre-processing hole with the aperture D1 until the back-end cutting section of cutting portion of the tool extending out of the outlet side; and
if the front-end cutting section of cutting portion of the tool is mill end structure, adjusting the eccentricity e1 of the tool to e1=(D1−d)/2, driving the tool to helically mill with forward feeding to process the pre-processing hole with aperture D1 from the inlet side until the back-end cutting section of cutting portion of the tool extending out of the outlet side; wherein, d is a diameter of the cutting portion of the tool.

5. The method according to claim 4, wherein step S5 comprises the following steps:
S51. if D−Di<d−d0, adjusting the eccentricity e of the tool to e=(D−d)/2, helically milling with backward feeding from the outlet side to process a hole with aperture D and coaxial with the pre-processing hole, to obtain the through-hole to-be-processed; wherein, Di is an aperture at the outlet side after the previous helical milling, d is the diameter of cutting portion of the tool, d0 is a diameter of neck portion of the tool, and i=1, 2, 3, 4 . . . ;
if D−Di≥d−d0, adjusting the eccentricity e(i+1) of the tool to satisfy ei<e(i+1)<ei+(d−d0)/2, helically milling with backward feeding from the outlet side to process a through-hole coaxial with the pre-processing hole; and adjusting the eccentricity to e0<e(i+1) and feeding forward to make the back-end cutting section of cutting portion of the tool to extend out of the outlet side; wherein, Di is the aperture at the outlet side after the previous helical milling, d is the diameter of cutting portion of the tool, d0 is the diameter of neck portion of the tool, ei is an eccentricity of the tool when the aperture at the outlet is Di, e(i+1) is an eccentricity of the tool in the present helical milling, and i=1, 2, 3, 4 . . . ; and
S52. repeating step S51.

6. The method according to claim 1, wherein a driving device of the tool is a machining center, or a special equipment for helical milling with eccentricity automatic adjustment function, or other processing equipment that can drive the tool to realize the motion required by the present disclosure.

7. The method according to claim 5, wherein a method for helical milling with backward feeding from the outlet side comprises: the tool feeds to the outlet side along a helical path while it rotates at a high speed, and perform helical milling of the outlet side by the back-end cutting section of cutting portion of the tool.

8. The method according to claim 1, wherein before step S5, the tool helically mills with forward feeding from the inlet side, to obtain a hole with an aperture D, a hole depth H1 and coaxial with the pre-processing hole, and feeds forward after the eccentricity of the tool is reduced, until the back-end cutting section of the cutting portion of the tool extends out of the outlet side; wherein, H1<H, H is the hole depth of the through-hole; and
step S5 comprises the following steps:
adjusting the eccentricity of the tool one or more times, helically milling with backward feeding from the outlet side, processing a hole with an aperture D, a hole depth H−H1 and coaxial with the pre-processing hole, to obtain the through-hole to-be-processed; the front-end cutting section of cutting portion of the tool is the end milling structure.
